(19) United States
(12) Patent Application Publication
(10) Pub. No.: US 2010/0270092 A1
(43) Pub. Date: Oct. 28, 2010

(54) SELF-PROPELLED STEERABLE JOCKEY WHEEL

(75) Inventor: Hilary Eric Hanslow, Ballina (AU)

Correspondence Address: DARBY & DARBY P.C., P.O. BOX 770, Church Street Station, New York, NY, 10008-0770, US

(73) Assignee: TRAVELONGER PTY LTD., Ballina (AU)

(21) Appl. No.: 12/671,186

(22) PCT Filed: Jul. 21, 2008
(86) PCT No.: PCT/AU2008/001056

§ 371 Date: Jan. 28, 2010

(30) Foreign Application Priority Data
Jul. 30, 2007 (AU) 2007904089

(51) Int. Cl. B60S 9/00; B60S 13/00; B62D 63/08

(52) U.S. Cl. 180/11; 280/3

(57) ABSTRACT

A self propelled, steerable jockey wheel assembly for a trailer or vehicle, the assembly including an attachment means to attach the assembly relative to the trailer or vehicle, a length adjustable support associated with the attachment means and at least one wheel located at a lower end of the length adjustable support to support the load of the trailer or vehicle and engage a ground surface.

### FIELD OF THE INVENTION

The present invention relates to a jockey wheel. In particular, the present invention relates to a self propelled, steerable jockey wheel assembly, such as for use with a trailer or vehicle.

### BACKGROUND ART

There are a number of devices, such as box trailers, boat trailers, car trailers or the like, horse or animal floats, caravans and so on which, in use, are towed behind another, typically self-propelled, vehicle. These devices are, for the sake of convenience, referred to collectively as “trailers”.

When a trailer is connected to a self-propelled vehicle (a car, truck or the like), it may be easily transported between locations. However, conventional trailers do not have their own propulsion system, meaning that moving a trailer by itself, such as when moving the trailer to connect it to, or disconnect it from, a motorized vehicle must be performed manually. In many circumstances, such as when the trailer is large, heavy, or fully laden, this can be extremely difficult, and has the potential to result in injury to the person moving the trailer or damage to the trailer, vehicle or other structures.

In addition, there are some self-propelled vehicles, such as aeroplanes, wherein using the vehicle's own propulsion system to move the vehicle a short distance would constitute an inefficient use of fuel and may cause wear or similar damage to the propulsion system.

Some attempts have been made to provide such a device. U.S. Pat. No. 6,945,343, for instance, discloses a self-propelled jockey wheel assembly which is connected to a trailer tongue jack. However, this device suffers from the significant drawback that it requires the presence of an existing tongue jack in order to be able to function and is difficult and time consuming to install.

In light of the foregoing, it would be advantageous if it were possible to provide a device that allowed vehicles (whether self-propelled vehicles or trailers) to be moved without requiring the use of the vehicle's own propulsion system or a physical exertion on the part of a user, or the use of a second vehicle (e.g. for towing). Furthermore, it would be advantageous if the device could be adapted for use with a variety of vehicles (whether self-propelled vehicles or trailers).

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### OBJECT OF THE INVENTION

It is an object of the present invention to provide a jockey wheel assembly which may overcome at least some of the abovementioned disadvantages, or provide a useful or commercial choice.

In one aspect, the invention resides broadly in a self propelled, steerable jockey wheel assembly for a trailer or vehicle, the assembly including an attachment means to attach the assembly relative to the trailer or vehicle, a support column associated with the attachment means and at least one wheel located at a lower end of the support column to support the load of the trailer or vehicle and engage a ground surface.

In this form, the invention is directed towards a self propelled, steerable jockey wheel assembly for a trailer or vehicle. The provision of such a self propelled jockey wheel would dramatically assist mobility and the ability to move and manoeuvre a heavy or cumbersome trailer or vehicle.

It is preferred that the jockey wheel be provided in a compact self contained unit. Preferably, the jockey wheel of the present invention is adapted to be permanently or semi-permanently connected to a vehicle or trailer. In this way, the user may ensure that the jockey wheel does not get left behind when the vehicle or trailer is moved.

Alternatively, in some embodiments of the invention, the jockey wheel may be adapted to be interchangeable between various vehicles or trailers that a single user may own.

The jockey wheel of the invention is a powered jockey wheel. That is, the jockey wheel does not require a user to drag the entire weight of the vehicle/trailer when moving. Although the assembly is referred to as a jockey wheel assembly, there may be more than one wheel provided.

It is envisaged that the jockey wheel assembly will include an electric motor which can be energised by at least one battery and where the electric motor drives at least one wheel. As an example, the motor may be a “hub” motor inside or adjacent a wheel to drive that wheel. Alternatively, the motor may drive an axle and one or more wheels may be rigidly mounted to the axle. In another alternative, the motor may drive a wheel using a drive chain, drive pulley, drive shaft and the like. The motor may be provided inside the support column.

It is also envisaged that the assembly may be propelled by another drive member which may be separate from the wheel supporting the load. This drive member may comprise a further ground wheel, roller etc which can drive the assembly.

Preferably, the motor is located at a point above the jockey wheel axle. In this way, the jockey wheel may be used to move the vehicle or trailer through water without damaging the motor.

It is envisaged that the invention may also encompass a jockey wheel assembly where the electric motor is replaced with an internal combustion motor or the like. With this apparatus, a battery may not be required to drive the motor.

Although the assembly may comprise an electric motor and an on-board battery, there are certain situations when, for instance, a hydraulic motor (and battery) may be desirable. Such situations include if the jockey wheel assembly is intended to be partly or completely submerged in water, such as when the jockey wheel assembly is connected to a boat trailer or the like. In this way, the jockey wheel assembly may be used in the water without the danger of causing water damage to the motor, which would be the case with an electric motor.

Preferably, the motor is a variable speed motor. By providing the assembly with a variable speed motor, the speed of the trailer or vehicle may be more readily controlled during use of the jockey wheel assembly.

The motor may comprise any suitable type of motor and will typically comprise a commercially available motor operating anywhere between 6-24V.

The battery may comprise a single battery or a number of batteries (e.g. a battery pack). It is envisaged that these will be rechargeable possibly from mains power or other power supply. The battery is preferably positioned on the assembly but may be stored on the trailer or vehicle.

Some form of accelerator or throttle will typically be provided to vary the power to the motor and to enable the speed of the trailer or vehicle to be varied. This may be in the form of a continuous accelerator or in the form of a switch (for instance having a low, medium, high speed setting) or the like. This may be accomplished by remote control or the like.

The jockey wheel of the invention is also steerable. There are various means of steering a jockey wheel assembly and the method used may depend upon the level of complexity and cost for example. One preferred method may be to attach a steering member to a portion of the assembly, typically the wheel (but possibly the support associated with the attachment means if moveable relative to the trailer or vehicle) to allow a manual form of steering.

Alternatively, the steering method may involve a power assisted steering. Such a steering method may involve provision of one or more means such as hydraulic or air rams or cables, to steer the wheel assembly. A single ram may be provided or a pair of opposed cables for example.

In embodiments of the invention in which the steering method involves power assisted steering, control means may be provided to allow a user to control the steering of the vehicle or trailer and/or the vertical height of the support. Any suitable means may be provided, such as, but not limited to, one or more manual controls. The manual controls may be in the form of one or more buttons, levers, knobs, dials, joysticks or the like, or any combination thereof. The controls may be provided in any suitable location. However, in some embodiments of the invention, the controls may be provided on one or more control panels. The one or more control panels may be located on the vehicle or trailer, for instance on the frame of the vehicle or trailer. In a preferred embodiment of the invention, the one or more control panels may be provided with a cover in order to protect the controls from damage caused by the elements, accidental contact with structures or other vehicles, vandalism or the like. In this embodiment of the invention, the cover of the one or more control panels may be provided with locking or latching means to prevent an unauthorised person gaining access to the control panels.

In another embodiment of the invention, the control means may be provided in the form of a remote control that allows a user to remotely operate the steering mechanism. In this embodiment of the invention, the assembly may still be provided with one or more control panels as well as being provided with a remote control, or the remote control may be provided instead of one or more control panels.

In some embodiments of the invention, the one or more control panels and/or remote controls may be adapted to control the steering of the vehicle, the speed of the motor, the braking of the trailer or vehicle or any combination thereof.

The jockey wheel of the invention includes an attachment means to attach the assembly relative to the trailer or vehicle. The attachment means will normally attach the wheel assembly to a main support of a trailer or vehicle and as such may include a sleeve or similar to be fixed about a support frame member of the trailer or vehicle. The fixing of the sleeve will typically be using bolts or threaded fasteners to clamp the sleeve to the support frame member.

A swivel or pivot point will normally be provided to allow the length adjustable support of the assembly to rotate relative to the attachment means from a use condition in which the wheel is lowermost and a storage condition in which the length adjustable support is substantially parallel to the frame of the trailer or vehicle with the wheel clear of the ground. The storage condition is typically used when the trailer is under tow.

The swivel or pivot point will preferably have a releasable catch or locking arrangement to temporarily lock the length adjustable support relative to the attachment means. Movement of the assembly between the storage and use condition may be assisted by mechanical assistance such as a ram or similar. The ram may be located to move the support by either expansion or contraction.

The jockey wheel assembly of the invention also includes a support column associated with the attachment means. The support will typically be a heavy duty support capable of bearing large loads without deformation. The support may be length adjustable in any manner, perhaps most effectively by providing the support as, or including a hydraulic ram. Other types of support may be used such as a support which is length adjustable utilising a winding action or similar.

The support column may be manufactured of box section metal. The drive mechanism may be located inside the hollow box support column.

The support may be formed from a plurality of members which engage each other in order to be length adjustable. Therefore, the members may be telescopic for example. The support may extend above the frame of the trailer or vehicle.

The jockey wheel assembly of the invention also includes a wheel assembly located at a lower end of the length adjustable support to engage a ground surface. As stated above, more than one wheel may be provided, and typically, a pair of wheels will be provided given the weight of the load and the potential for slippage.

The frame of the trailer or vehicle may be adapted to the use of the jockey wheel in particular, a space may be provided to allow the jockey wheel assembly to be received within the frame in the storage condition.

In a preferred embodiment of the invention, the jockey wheel assembly is adapted to be located in the centre of the fork or frame of a trailer or vehicle. Preferably, the jockey wheel assembly is adapted for connection to two or more points on the trailer or vehicle fork or frame. In this way, the jockey wheel assembly provides the vehicle or trailer with additional stability (both during movement of the vehicle or trailer and while the vehicle or trailer is stationary) not provided by prior art jockey wheels.

In some embodiments of the invention, the jockey wheel assembly may be provided with a frame or cage or the like adapted to partially surround or enclose the assembly in the storage condition. In some embodiments of the invention, the frame or cage may extend above the level of the frame or chassis of the vehicle or trailer. The frame or cage may be adapted to provide the jockey wheel assembly with sufficient clearance such that when the jockey wheel assembly is in the storage condition, the one or more wheels are maintained well clear of the ground. Alternatively, the frame or cage may be adapted to provide protection for the jockey wheel assembly during use, during such circumstances as a collision or the like, or from contact with structures or other vehicles.

It is envisaged that the jockey wheel of the present invention could be used with a variety of vehicles or trailers, such as, but not limited to, box trailers, car or boat trailers, horse or animal floats, caravans, aircraft or the like. Preferably, the jockey wheel of the present invention, due to the sturdy and rugged nature of its construction, may be suitable for use with heavy vehicles or trailers (for instance, vehicles and trailers of 2000 kg in weight or greater).

In embodiments of the invention in which the jockey wheel assembly is to be used for larger or heavier vehicles or trailers, the construction of the jockey wheel assembly may be adapted to be sturdier and/or stronger. For instance, in these embodiments of the invention, thicker metal, larger box section members, or the like could be used to make the construction of the jockey wheel assembly sturdier and/or stronger.

### BRIEF DESCRIPTION OF THE DRAWINGS

An embodiment of the invention will be described with reference to the following drawings in which:

FIG. 1 illustrates a schematic view of a jockey wheel assembly according to an embodiment of the present invention;

FIG. 2 illustrates a plan view of a jockey wheel assembly according to an embodiment of the present invention;

FIG. 3 illustrates a jockey wheel assembly according to an embodiment of the present invention when in use;

FIG. 4 illustrates a jockey wheel assembly according to an embodiment of the present invention when in a storage condition;

FIG. 5 illustrates a jockey wheel assembly according to an embodiment of the present invention;

FIG. 6 illustrates a jockey wheel assembly according to an embodiment of the present invention when in the storage condition;

FIG. 7 illustrates a jockey wheel assembly according to an embodiment of the present invention;

FIG. 8 illustrates a jockey wheel assembly according to an embodiment of the present invention.

### DETAILED DESCRIPTION OF THE DRAWINGS

It will be appreciated that the drawings have been provided for the purposes of illustrating preferred embodiments of the present invention and that the invention should not be considered to be limited solely to the features as shown in the drawings.

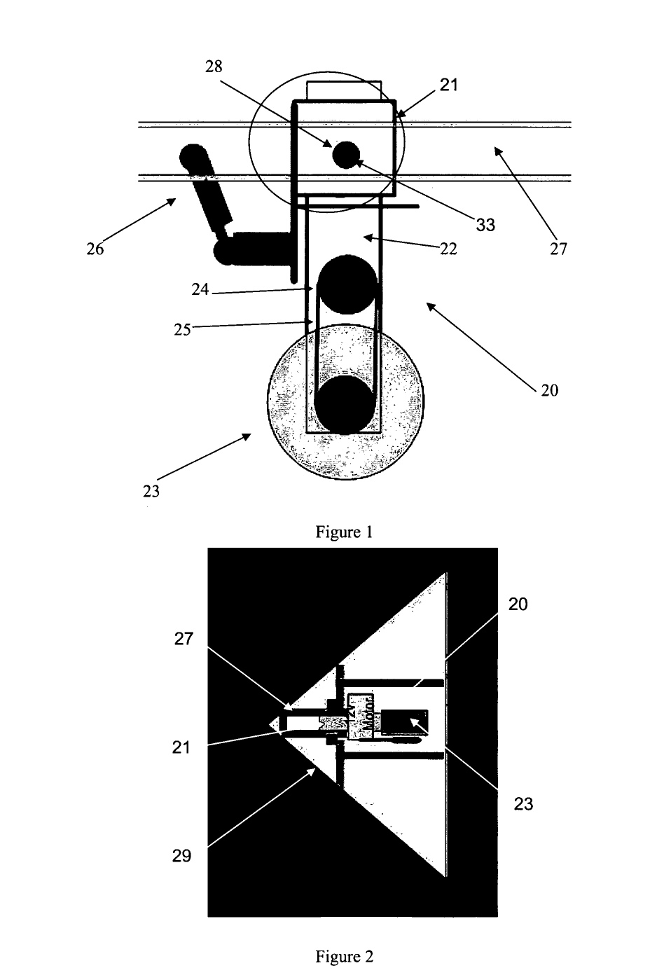

As illustrated in FIG. 1 in particular, the jockey wheel assembly 20 includes an attachment sleeve 21 to attach the assembly relative to the trailer, a length adjustable support 22 associated with the attachment sleeve 21 and a wheel 23 located at a lower end of the length adjustable support 22 to support the load of the trailer and engage a ground surface.

The jockey wheel assembly 20 illustrated includes an electric motor 24 which can be energised by a battery (not shown) and the electric motor 24 drives the wheel 23, by engaging and driving an axle with the wheel 23 rigidly mounted to the axle. The motor is linked to the wheel using a drive chain 25.

The jockey wheel is also steerable. The preferred method is to attach a steering member (not shown) to a portion of the assembly.

The attachment sleeve 21 attaches to a main support 27 of a trailer. The sleeve is fixed to the support 27 using bolts to clamp the sleeve 21 to the support 27.

A swivel or pivot point 28 is provided to allow the length adjustable support of the assembly to rotate relative to the attachment sleeve from a use condition in which the wheel is lowermost and a storage condition in which the length adjustable support is substantially parallel to the frame of the trailer or vehicle with the wheel 23 clear of the ground. Preferably, a pin 33 is provided at the swivel or pivot point, the pin 33 adapted for connection to a vehicle or trailer (not shown).

The swivel or pivot point 28 includes a releasable catch or locking arrangement to temporarily lock the length adjustable support relative to the attachment sleeve. According to the illustrated embodiment, movement of the jockey wheel between the storage and use condition is assisted a ram 26.

The length adjustable support also includes a hydraulic ram to lengthen and contract the support.

In FIG. 2, the jockey wheel assembly 20 is shown when in a storage position within the tongue 29 of a trailer. The sleeve 21 of the jockey wheel assembly 20 is pivotally attached to the support 27 such that the assembly 20 may be pivoted into the storage condition shown in FIG. 2. In this position, the jockey wheel assembly is substantially parallel to the support 27 with the wheel 23 clear of the ground.

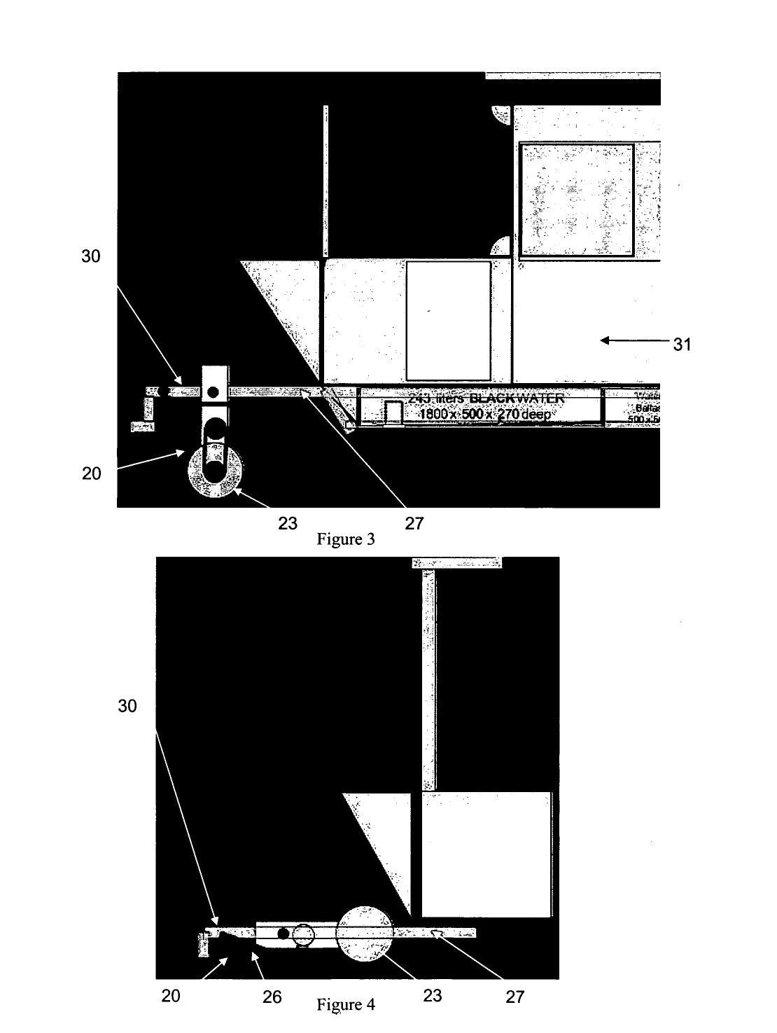

In FIG. 3, the jockey wheel assembly 20 is shown when connected to a trailer 30 adapted to transport a boat 31. The jockey wheel assembly 20 is shown in a use condition in which the assembly is disposed substantially at 90° to the support 27 such that the wheel 23 is in contact with the ground. This position would be used when the trailer 30 must be moved but is not connected to another vehicle (such as a car or truck).

By contrast, FIG. 4 illustrates a situation in which the jockey wheel assembly 20 is in the storage condition. In this condition, the assembly 20 is located substantially parallel to the support 27 such that the wheel 23 is maintained clear of the ground. This position would be used when the trailer 30 is connected to another vehicle (not shown) and the trailer 30 is being transported under tow. The assembly 20 is pivoted between the use condition illustrated in FIG. 3 and the storage condition illustrated in FIG. 4 by actuation of a hydraulic ram 26.

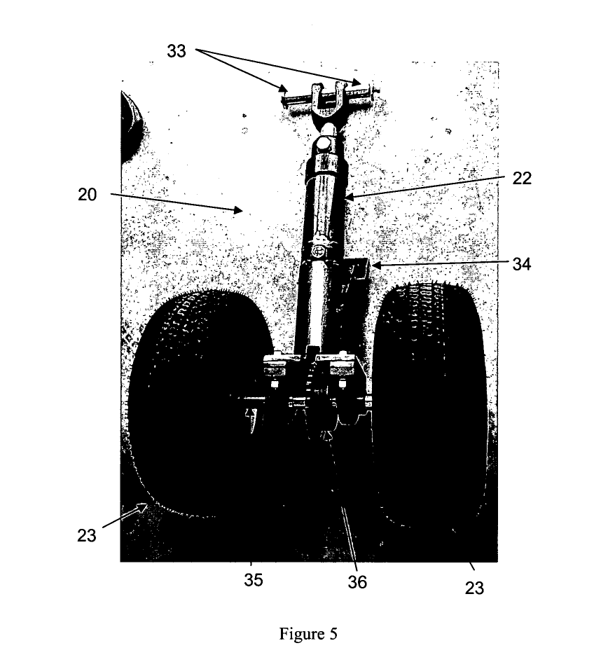

In FIG. 5, a jockey wheel assembly 20 according to an embodiment of the present invention is illustrated. The assembly comprises a pair of wheels 23 mounted at the lower end of a length adjustable support 22. The assembly 20 is adapted for connection to a support (not shown) using a pin 33.

A motor (not shown) is mounted to the assembly 20 via a mounting plate 34. Actuation of the motor transfers drive to the wheel axle 35 via a drive chain (not shown) engaged with a gear wheel 36.

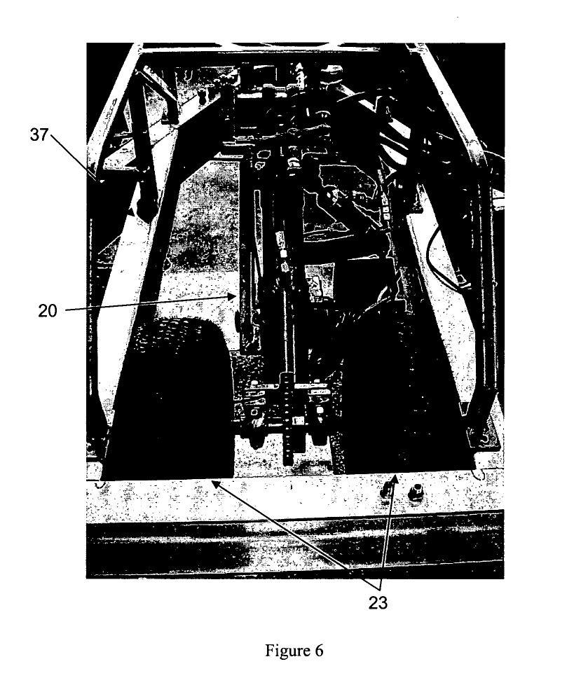

In FIG. 6, a jockey wheel assembly 20 is shown connected to the frame of a trailer 37 in the storage condition. In this condition the assembly 20 is maintained substantially parallel to the frame of the trailer 37 such that the wheels 23 are maintained well clear of the ground.

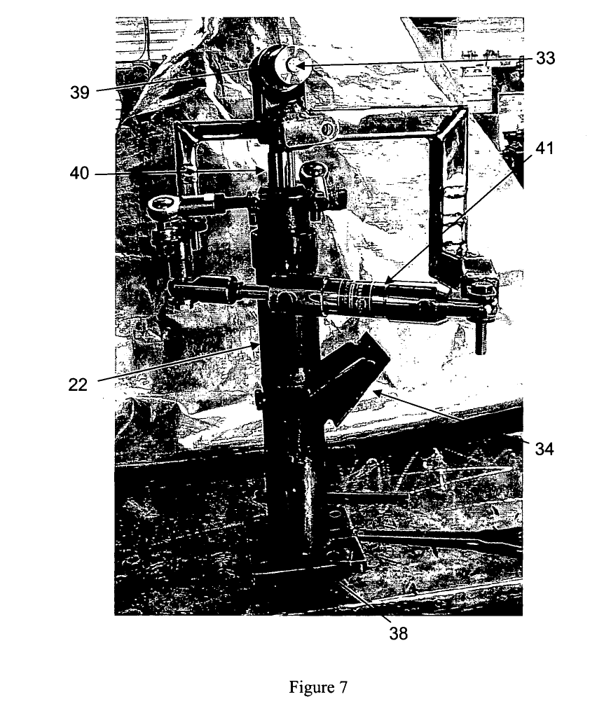

In FIG. 7, a length adjustable support 22 according to an embodiment of the present invention is illustrated. The lower end of the support 22 comprises a bracket 38 adapted for connection to the wheel axle (not shown) and a mounting plate 34 to which a motor may be connected.

A hinge 39 is located at an upper end of the support 22. In use, the hinge 39 is adapted to at least partly surround the pin 33, the pin 33 being adapted for connection to a trailer or vehicle (not shown). The assembly swivels around the hinge 39 when moving between the storage condition and the use condition. In a preferred embodiment of the invention, the hinge 39 is welded or otherwise connected to the frame of the vehicle or trailer (not shown).

The support 22 further comprises a first hydraulic ram 40 adapted to provide the assembly with vertical lift, and a second hydraulic ram 41 adapted to be used when steering the assembly when attached to a trailer or vehicle.

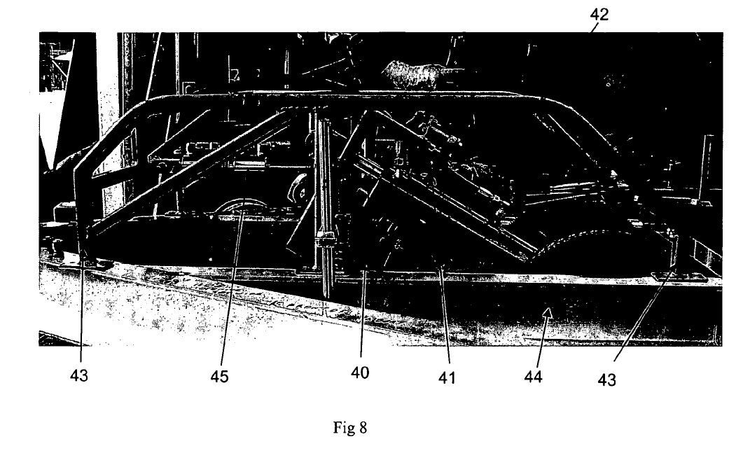

In FIG. 8 a jockey wheel assembly according to an embodiment of the present invention is illustrated. The jockey wheel assembly is partially surrounded by a frame which is in turn connected to the chassis or a vehicle or trailer. The frame is adapted to extend upwardly above the level of the chassis in order to provide the jockey wheel assembly with sufficient clearance such that, when the assembly is in the storage condition, the wheels are maintained clear of the ground. In addition, the cage or frame provides the jockey wheel assembly with some protection from impact or contact from the side and above.

In FIG. 8, there is further shown a first hydraulic ram 40 adapted to provide the assembly with vertical lift, a second hydraulic ram 41 for steerage and a third hydraulic ram 45 for raising and lowering the assembly to and from the stowage position.

The frame 42 has a number of legs 43 which may be bolted to the chassis 44 of the trailer. Smaller models of the jockey wheel assembly may have fewer legs or even no legs depending on the height requirement of the trailer. Bolting the frame 42 to the chassis 44 serves to allow the frame 42 to act as an extension of the chassis 44. The frame 42 may not be required on trailer entering the water. In this situation, the double-sided weight bearing swivel/pivot point (hinge 39) and other hydraulic connections could be at chassis level.

Those skilled in the art will appreciate that the present invention may be susceptible to variations and modifications other than those specifically described. It will be understood that the present invention encompasses all such variations and modifications that fall within its spirit and scope.

1. A self propelled, steerable jockey wheel assembly for a trailer or vehicle, the assembly including an attachment means to attach the assembly relative to the trailer or vehicle, a length adjustable support associated with the attachment means and at least one wheel located at a lower end of the length adjustable support to support the load of the trailer or vehicle and engage a ground surface.

2. An assembly according to claim 1 wherein the assembly is adapted for attachment to two or more points on a vehicle or trailer.

3. An assembly according to claim 1 wherein the assembly is adapted to be located in a fork or frame of a vehicle or trailer.

4. An assembly according to claim 1 wherein the assembly comprises two or more wheels.

5. An assembly according to claim 1 wherein the assembly further comprises a motor.

6. An assembly according to claim 5 wherein the motor is an electric motor.

7. An assembly according to claim 5 wherein the motor is a hydraulic motor.

8. An assembly according to claim 5 wherein motor power is varied by providing an accelerator or throttle.

9. An assembly according to claim 1 wherein the assembly further comprises a steering member.

10. An assembly according to claim 9 wherein the steering member is adapted for manual steering.

11. An assembly according to claim 9 wherein the steering member is power assisted.

12. An assembly according to claim 11 wherein the steering member comprises one or more hydraulic rams, air rams, cables, or any combination thereof.

13. An assembly according to claim 1 wherein the assembly comprises a swivel or pivot point, the swivel or pivot point adapted to allow the assembly to swivel or pivot between a use condition and a storage condition.

14. An assembly according to claim 13 wherein, when the assembly is in the use position, the at least one wheel engages the ground surface.

15. An assembly according to claim 13 wherein, when the assembly is in the storage position, the assembly is substantially parallel to a frame of the trailer or vehicle.

16. An assembly according to claim 1 wherein the assembly further comprises a frame or cage adapted to extend upwardly from a frame or chassis of a trailer or vehicle.

17. An assembly according to claim 1 wherein the trailer or vehicle comprises box trailers, car or boat trailers, horse or animal floats, caravans or aircraft.

18. A self propelled, steerable jockey wheel assembly for a trailer or vehicle, the assembly including an attachment means to attach the assembly relative to the trailer or vehicle, a length adjustable support associated with the attachment means, at least one wheel located at a lower end of the length adjustable support to support the load of the trailer or vehicle and engage a ground surface, and a frame or cage adapted to extend upwardly from a frame or chassis of a trailer or vehicle, wherein the assembly is adapted for movement between a use position in which the at least one wheel engages the ground surface, and a storage position in which the at least one wheel is adapted to be at least partially housed within the upwardly extending frame or cage.

19. An assembly according to claim 18 wherein the jockey wheel assembly is fixedly attached to the trailer or vehicle.
